(19) United States
(12) Patent Application Publication
(10) Pub. No.: US 2025/0061506 A1
(43) Pub. Date: Feb. 20, 2025

(54) SYSTEMS AND METHODS FOR GENERATING RECOMMENDATIONS USING CONTEXTUAL BANDIT MODELS WITH NON-LINEAR ORACLES

(71) Applicant: INTUIT INC., Mountain View, CA (US)

(72) Inventors: Shankar SANKARARAMAN, Mountain View, CA (US); Isaac STORCH, Mountain View, CA (US)

(73) Assignee: INTUIT INC., Mountain View, CA (US)

(21) Appl. No.: 18/450,931

(22) Filed: Aug. 16, 2023

(51) Int. Cl. G06Q 30/0601

(52) U.S. Cl. CPC G06Q 30/0631

(57) ABSTRACT

Systems and methods are provided for generating recommendations using contextual bandit models with non-linear oracles.

### BACKGROUND OF THE DISCLOSURE

Contextual bandit models (also referred to herein as “contextual bandits”) are a common approach for generating user-item personalized recommendations. This typically improves customer experience, engagement, retention, and conversion on various platforms, such as websites (e.g., TurboTax™, Credit Karma™, Uber™, etc.) and content platforms (e.g., Netflix™, YouTube™, etc.). The first general concept of a contextual bandit model is that it uses a supervised model as a reward-predicting oracle and intelligently chooses between exploitation (exploiting the oracle to maximize reward) and exploration (exploring items that may not have been suggested by the oracle). An oracle is a model that predicts the reward that can be obtained for an item when it is recommended to the user. The second general concept of a contextual bandit model is that it (often continuously) updates the oracle based on the continuous rewards/feedback received from user-item interactions.

Because linear models are often the most suitable for supporting multiple exploration strategies and continuous learning architectures in general, many contextual bandit implementations use linear and generalized linear models as oracles. However, in machine learning applications, non-linear models, such as tree-based or deep learning models, tend to be more accurate and require less feature engineering. But applying tree-based oracles in contextual bandits is not straightforward and creates several challenges. For example, one challenge while training such a non-linear model is that the oracle may identify that certain item-features are not important and as a result, predict equal scores for all possible content items, thereby making it impossible to make recommendations across these items.

### BRIEF DESCRIPTION OF THE FIGURES

FIG. 1 is a block diagram of an example system for generating recommendations using contextual bandit models with non-linear oracles according to example embodiments of the present disclosure.

FIG. 2 is a flowchart of an example process for training a non-linear oracle for use in conjunction with a contextual bandit model according to example embodiments of the present disclosure.

FIG. 3 is flowchart of an example process for generating recommendations using contextual bandit models with non-linear oracles according to example embodiments of the present disclosure.

FIGS. 4A-4C illustrate potential exemplary user interfaces according to some embodiments of the present disclosure.

FIG. 5 is an example server device that can be used within the system of FIG. 1 according to an embodiment of the present disclosure.

FIG. 6 is an example computing device that can be used within the system of FIG. 1 according to an embodiment of the present disclosure.

### DESCRIPTION

The following detailed description is merely exemplary in nature and is not intended to limit the claimed invention or the applications of its use.

Embodiments of the present disclosure relate to systems and methods for generating recommendations using contextual bandit models with non-linear oracles. The disclosed contextual bandit architecture can be used to make recommendations on various sets of items, such as news articles, financial insights, UI elements, movies, television programs, and user-experiences. According to example embodiments of the present disclosure, a non-linear (tree-based or deep learning) model can be used as the oracle in a contextual bandit recommendation architecture. As discussed above, the non-linear oracle predicts the reward that can be obtained for each item when it is recommended to a user. The disclosed oracle utilizes user features (e.g., financial information, age, sex, etc.), item features (e.g., features/genres/characteristics of the items being recommended), and context features (e.g., time of day/week, device being used, location, etc.) to train the machine learning model to predict the resulting reward. In addition, the disclosed contextual bandit architecture utilizes specific hyperparameters (i.e., feature weights) for the model and a new metric that can be used as an optimization constraint during training.

Moreover, the disclosed systems and methods overcome the above-mentioned challenges by utilizing a model that is constructed to differentiate between item features and other features (both user and context features). For example, this can be achieved by training one oracle for all items under consideration as possible recommendations.

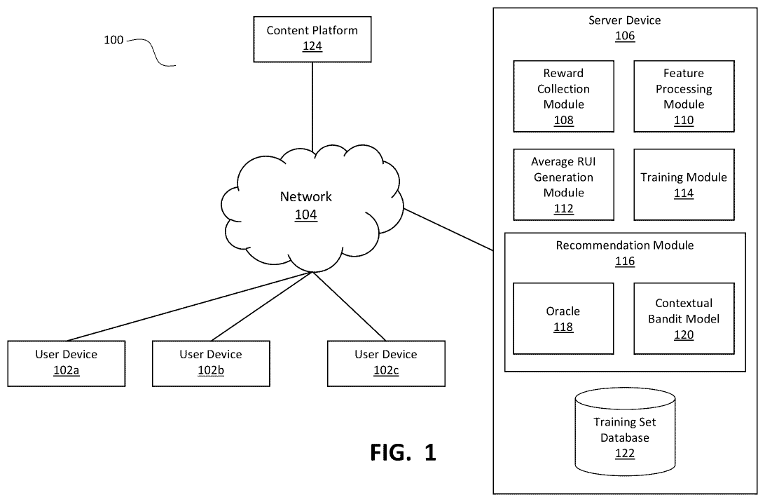

FIG. 1 is a block diagram of an example system 100 for generating recommendations using contextual bandit models with non-linear oracles according to example embodiments of the present disclosure. The system 100 can include a plurality of user devices 102a-n (generally referred to herein as a “user device 102” or collectively referred to herein as “user devices 102”) that can access a content platform 124 and a server 106, which are communicably coupled via a network 104. In some embodiments, the system 100 can include any number of user devices 102. For example, for a content platform or other website that may offer recommendations to users, there may be an extensive userbase with thousands or even millions of users that connect to the system 100 via their user devices 102. For example, a user, via a user device 102, may visit a content platform that is monitored and or controlled by the server 106. The server 106 can analyze various features to generate one or more recommendations to the user as they access the platform. For example, when a user visits YouTube®, there may be multiple recommended videos displayed on the home page. Similar lists of recommendations exist on other platforms, as well.

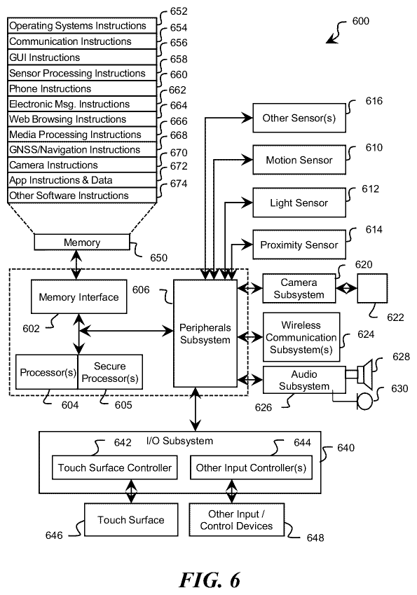

A user device 102 can include one or more computing devices capable of receiving user input, transmitting and/or receiving data via the network 104, and or communicating with the server 106. In some embodiments, a user device 102 can be a conventional computer system, such as a desktop or laptop computer. Alternatively, a user device 102 can be a device having computer functionality, such as a personal digital assistant (PDA), a mobile telephone, a smartphone, or other suitable device. In some embodiments, a user device 102 can be the same as or similar to the computing device 600 described below with respect to FIG. 6.

The network 104 can include one or more wide areas networks (WANs), metropolitan area networks (MANs), local area networks (LANs), personal area networks (PANs), or any combination of these networks. The network 104 can include a combination of one or more types of networks, such as Internet, intranet, Ethernet, twisted-pair, coaxial cable, fiber optic, cellular, satellite, IEEE 801.11, terrestrial, and/or other types of wired or wireless networks. The network 104 can also use standard communication technologies and/or protocols.

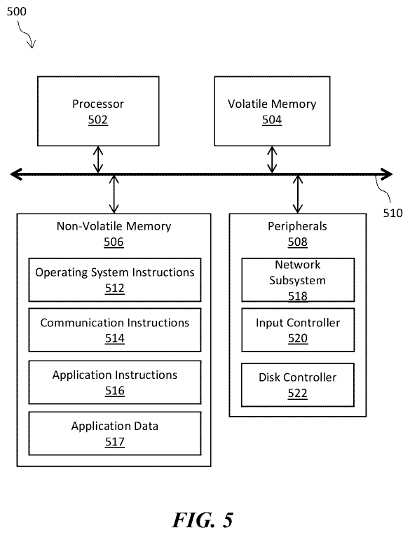

The server 106 may include any combination of one or more of web servers, mainframe computers, general-purpose computers, personal computers, or other types of computing devices. The server 106 may represent distributed servers that are remotely located and communicate over a communications network, or over a dedicated network such as a local area network (LAN). The server 106 may also include one or more back-end servers for carrying out one or more aspects of the present disclosure. In some embodiments, the server 106 may be the same as or similar to server 500 described below in the context of FIG. 5.

As shown in FIG. 1, the server 106 can include a reward collection module 108, feature processing module 110, average reward uniqueness indicator (“average RUI”) generation module 112, training module 114, recommendation module 116, and a training set database 122. In some embodiments, the recommendation module 116 can include an oracle 118 and a contextual bandit model 120.

In some embodiments, the reward collection module 108 is configured to collect/receive rewards from users' interactions with items, such as content items. In some embodiments, the rewards can be binary, such as whether the interaction resulted in the user clicking on a recommended item or not. In some embodiments, the rewards can be multi-class. For example, the user could have rated the recommended item on a relevance scale, such as from one to five. In some embodiments, the rewards can be continuous or near continuous. For example, the recommended item could have generated a revenue that continuously varies between $0 and $100.

In some embodiments, the feature processing module 110 is configured to concatenate user features, item features, and context features. The feature processing module 110 can then create an “X vector” that has an associated “Y value”, which is the collected reward.

In some embodiments, the average RUI generation module 112 is configured to calculate an average RUI value for a certain hyperparameter selection. In some embodiments, the average RUI can be calculated on the cross-validation data that is used for hyperparameter selection. In some embodiments, each row of the cross-validation data set can include a user-item combination. For each row, an item can be predicted. In other words, if there are N rows (index i) and M items (index j), a user i can be predicted for each of the M items. If the predicted rewards are different across the M items, then a value of one is assigned. If the predicted rewards are not different across the M items, then a value of zero is assigned. This process can be repeated for the rows in the cross-validation data. Then, the average RUI value can be calculated by dividing the number of one's by the number of rows. In some embodiments, the average RUI value can be a 0 or 1 variable that indicates whether the rewards across all items are unique. For example, for a given context (defined in terms of a set of interaction features), the reward is computed for each item; if all the reward values are unique, then the indicator value can be set to 1. Finally, an average across all available contexts in the data can be calculated, which can then be used to compute the average RUI value. It is important to note that, as an alternative to this metric, other measures (e.g., sample variance, Shannon's entropy, etc.) of item-level reward variance can also be used. However, benefits of the average RUI value can include interpretability (the metric is between 0 and 1, the higher the better) and sensitivity (the distance or difference between the item-level rewards are less than important than them just being different indicating that the model considered the item-features important and therefore, resulted in different rewards for each of the items).

In some embodiments, the training module 114 is configured to train the oracle 118 to predict the reward that can be obtained for each item when it is recommended to the customer. In some embodiments, the training module 114 can train the oracle 118 using various machine learning techniques such as XGBoost, RandomForest, lightGBM, Adaboost, and the like. In some embodiments, the training module 114 is configured to use various hyperparameters during the training phase of the oracle 118. For example, the training module 114 is configured to use hyperparameters such as the maximum number of leaves, maximum depth, etc., as well as an item feature-weights hyperparameter. Additionally, in some embodiments, the training module 114 is configured to train the oracle 118 using an optimization procedure, where the training module 114 attempts to perform a constrained optimization that 1) includes the item feature-weights as part of the hyperparameter search space; and 2) conforms to the constraint that the average RUI value should be greater than a pre-defined threshold (e.g., 0.95). In some embodiments, hyperparameter values that do not satisfy this constraint can be ignored, ensuring that 95% of the predictions will have differing rewards for the items. In some embodiments, the training module 114 is configured to continuously update the oracle 118 based on the continuous rewards and feedback received from user-item interactions (i.e., via the reward collection module 108).

In some embodiments, the recommendation module 116 utilizes both the oracle 118 and the contextual bandit model 120 to make recommendations to users in accordance with the platform it is used on (e.g., recommends books on a bookshop website, videos on a video sharing website, movies on a movie platform, etc.). In some embodiments, the contextual bandit model 120 is configured to generate recommendations to the user using a combination of exploitation (exploit the oracle to maximize reward) and exploration (explore items that may not have been suggested by the oracle). In some embodiments, the contextual bandit model 120 is configured to utilize an exploration policy such as epsilon-greedy. In some embodiments, the oracle 118 is configured to predict the reward that can be obtained for each item when it is recommended to the customer.

In some embodiments, the training set database 122 is configured to store various data that can be used to train the oracle 118, such as user features, item features, and context features. In some embodiments, the training set database 122 can include a plurality of X vectors and associated Y values. This can be used to train various models such as classification or regression models.

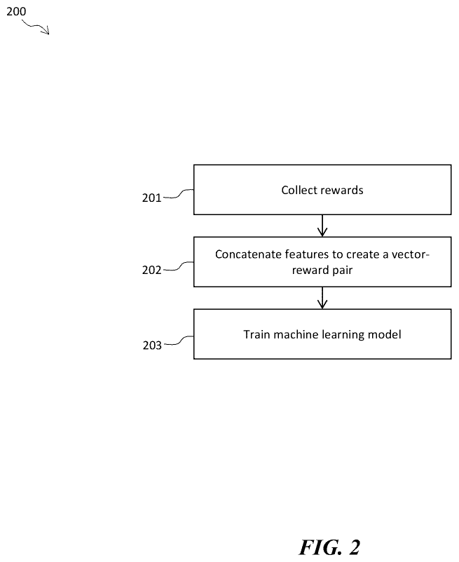

FIG. 2 is a flowchart of an example process 200 for training a non-linear oracle for use in conjunction with a contextual bandit model according to example embodiments of the present disclosure. In some embodiments, process 200 is performed within the system 100 of FIG. 1, such as by the server 106 and its various modules. At block 201, the reward collection module 108 collects rewards from users interacting with items recommended to them. For example, a user, via a user device 102, may be accessing the content platform 124. Once the platform 124 has been accessed, various recommendations may be displayed to the user. The reward collection module 108 can collect the rewards associated with these recommendations for the user as well as other users accessing the content platform 124. In some embodiments, the rewards received can be binary, multi-class, or continuous.

At block 202, the feature processing module 110 concatenates features to create a vector-reward pair. In some embodiments, the feature processing module 110 can perform the concatenation process for each interaction between a user and a recommended item on the content platform 124. In some embodiments, concatenating the features can include concatenating user features, item features, and context features to create an X vector. Then, the feature processing module 110 associates the reward (e.g., as a Y value) with the created X vector. In some embodiments, the feature vector and rewards data can be processed and joined/concatenated using various tools such as Python, Spark, Pandas, Numpy, etc.

At block 203, the training module 114 trains the machine learning model operating as the oracle 118. Training the machine learning model can include training the oracle 118 to predict the reward that can be obtained for each item when it is recommended to the customer in the future (i.e., future rewards). The possible items to recommend to the user will depend on the specific content platform 124. For example, it could be movies, tv shows, news articles, as well as many other examples. In some embodiments, the training module 114 can train the oracle 118 using various machine learning techniques such as XGBoost, RandomForest, lightGBM, Adaboost, and the like. In some embodiments, training the oracle 118 includes the average RUI module 112 calculating an average RUI value for the respective hyperparameter selections during training. Then, the training module 114 can train the oracle 118 using an optimization procedure, where the training module 114 attempts to perform a constrained optimization that 1) includes the item feature-weights as part of the hyperparameter search space; and 2) conforms to the constraint that the average RUI value should be greater than a pre-defined threshold (e.g., 0.95).

In some embodiments, the training module 114 is configured to use various hyperparameters during the training phase of the oracle 118. For example, the training module 114 is configured to use hyperparameters such as the maximum number of leaves, maximum depth, etc., as well as an item feature-weights hyperparameter. Additionally, in some embodiments, the training module 114 is configured to train the oracle 118 using an optimization procedure, where the training module 114 attempts to perform a constrained optimization that 1) includes the item feature-weights as part of the hyperparameter search space; and 2) conforms to the constraint that the average RUI value should be greater than a pre-defined threshold (such as 0.95, although various values can be used and this is merely exemplary in nature). In some embodiments, hyperparameter values that do not satisfy this constraint can be ignored, ensuring that 95% of the predictions will have differing rewards for the items. In some embodiments, the training module 114 is configured to continuously update the oracle 118 based on the continuous rewards and feedback received from user-item interactions (i.e., via the reward collection module 108).

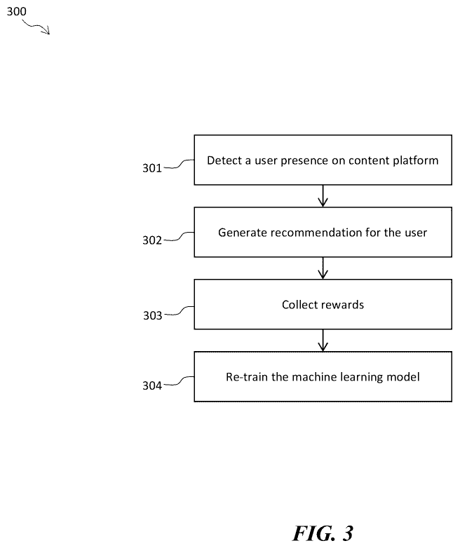

FIG. 3 is flowchart of an example process 300 for generating recommendations using contextual bandit models with non-linear oracles according to example embodiments of the present disclosure. In some embodiments, process 300 is performed within the system 100 of FIG. 1, such as by the server 106 and its various modules. At block 301, the server 106 detects the presence of a user (via a user device 102) accessing the content platform. For example, the server 106 can detect a user logging into Netflix® or YouTube®.

At block 302, the recommendation module 116 generates a recommendation for the user. In some embodiments, this can include multiple recommended items, such as a set of relevant videos that the user might be interested in. In some embodiments, the recommendation module 116 can generate the recommendation using the contextual bandit model 120. For example, the contextual bandit model 120 can generate a recommended item using either an exploration or an exploitation technique. In the case of an exploration technique, the contextual bandit model 120 can generate a random recommendation. In the case of an exploitation technique, the contextual bandit model 120 can generate a recommended item in an attempt to maximize the reward provided by the oracle 118. In these embodiments, the oracle 118 can analyze the user features (of the user accessing the content platform 124 via the user device 102), item features of the potential items to be recommended, and the context features with the trained machine learning algorithm. In some embodiments, the item can be recommended if the associated reward predicted by the oracle 118 is above a predefined threshold. In other embodiments, the item can be recommended if the associated reward predicted by the oracle 118 is the highest relative to other potential items. Regardless of how the contextual bandit model 120 generates a recommended item, the oracle 118 can predict the reward that would result therefrom.

At block 303, after the items are recommended to the user (e.g., caused to be displayed on the user device 102 that is accessing the content platform 124), the reward collection module 108 collects rewards from the associated user interacting with the recommended items. In some embodiments, the rewards received can be binary, multi-class, or continuous. At block 304, the training module 114 re-trains and or updates the oracle 118 within the recommendation module 116 based on the items recommended to the user and the associated rewards collected. In some embodiments, the re-training process can be the same as or similar to the training process 200 described in FIG. 2.

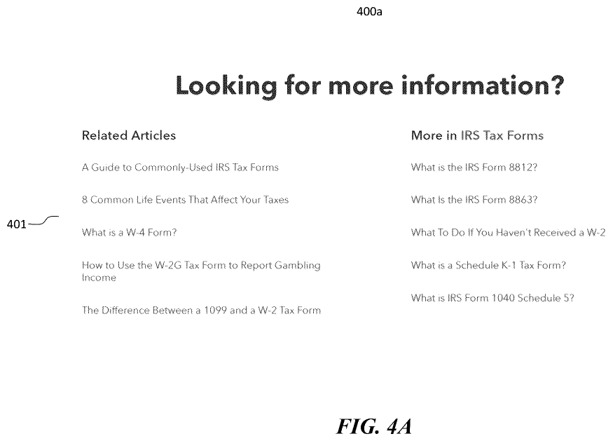

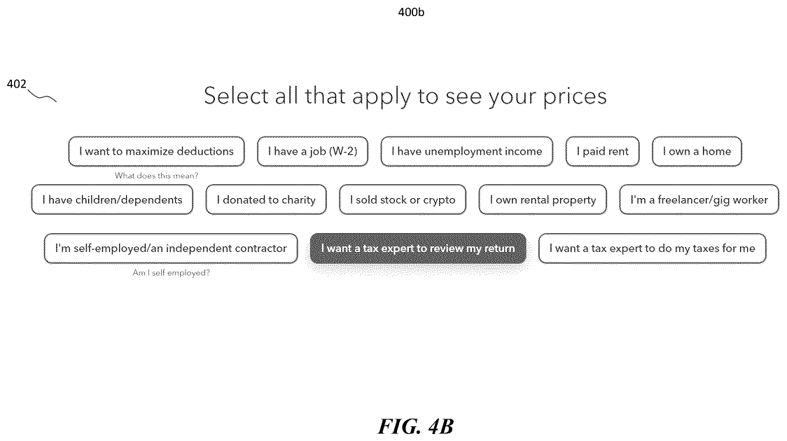

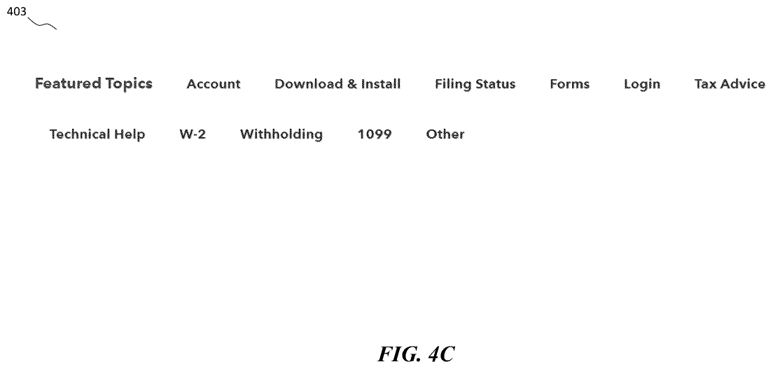

FIGS. 4A-4C illustrate potential exemplary user interfaces according to some embodiments of the present disclosure. For example, FIG. 4A shows an interface 400a that includes a list 401 comprising various “Related Articles.” Each of the links in the list 401 of recommended articles can have been generated by the disclosed embodiments.

Moreover, if a user selects any of those links, it can be considered a reward of 1. If a link is not clicked, it receives a reward of 0. FIG. 4B shows an interface 400b that includes a list 402 of rectangular tiles, each tile can have been generated via the disclosed embodiments. Similar to the list 401 of FIG. 4a, if a user selects any of those links, it can be considered a reward of 1. If a link is not clicked, it receives a reward of 0. Finally, FIG. 4C shows a list 403 of “Featured Topics,” where each recommended topic is generated by the disclosed embodiments. Users selecting various topics can be used to generate rewards for future recommendations. For example, if a user selects any of those links, it can be considered a reward of 1. If a link is not clicked, it receives a reward of 0.

FIG. 5 is a diagram of an example server device 500 that can be used within system 100 of FIG. 1. Server device 500 can implement various features and processes as described herein. Server device 500 can be implemented on any electronic device that runs software applications derived from complied instructions, including without limitation personal computers, servers, smart phones, media players, electronic tablets, game consoles, email devices, etc. In some implementations, server device 500 can include one or more processors 502, volatile memory 504, non-volatile memory 506, and one or more peripherals 508. These components can be interconnected by one or more computer buses 510.

Processor(s) 502 can use any known processor technology, including but not limited to graphics processors and multi-core processors. Suitable processors for the execution of a program of instructions can include, by way of example, both general and special purpose microprocessors, and the sole processor or one of multiple processors or cores, of any kind of computer. Bus 510 can be any known internal or external bus technology, including but not limited to ISA, EISA, PCI, PCI Express, USB, Serial ATA, or FireWire. Volatile memory 504 can include, for example, SDRAM. Processor 502 can receive instructions and data from a read-only memory or a random access memory or both. Essential elements of a computer can include a processor for executing instructions and one or more memories for storing instructions and data.

Non-volatile memory 506 can include by way of example semiconductor memory devices, such as EPROM, EEPROM, and flash memory devices; magnetic disks such as internal hard disks and removable disks; magneto-optical disks; and CD-ROM and DVD-ROM disks. Non-volatile memory 506 can store various computer instructions including operating system instructions 512, communication instructions 514, application instructions 516, and application data 517. Operating system instructions 512 can include instructions for implementing an operating system (e.g., Mac OS®, Windows®, or Linux). The operating system can be multi-user, multiprocessing, multitasking, multithreading, real-time, and the like. Communication instructions 514 can include network communications instructions, for example, software for implementing communication protocols, such as TCP/IP, HTTP, Ethernet, telephony, etc. Application instructions 516 can include instructions for various applications. Application data 517 can include data corresponding to the applications.

Peripherals 508 can be included within server device 500 or operatively coupled to communicate with server device 500. Peripherals 508 can include, for example, network subsystem 518, input controller 520, and disk controller 522. Network subsystem 518 can include, for example, an Ethernet of WiFi adapter. Input controller 520 can be any known input device technology, including but not limited to a keyboard (including a virtual keyboard), mouse, track ball, and touch-sensitive pad or display. Disk controller 522 can include one or more mass storage devices for storing data files; such devices include magnetic disks, such as internal hard disks and removable disks; magneto-optical disks; and optical disks.

FIG. 6 is an example computing device that can be used within the system 100 of FIG. 1, according to an embodiment of the present disclosure. In some embodiments, device 600 can be user device 102. The illustrative user device 600 can include a memory interface 602, one or more data processors, image processors, central processing units 604, and or secure processing units 605, and peripherals subsystem 606. Memory interface 602, one or more central processing units 604 and or secure processing units 605, and or peripherals subsystem 606 can be separate components or can be integrated in one or more integrated circuits. The various components in user device 600 can be coupled by one or more communication buses or signal lines.

Sensors, devices, and subsystems can be coupled to peripherals subsystem 606 to facilitate multiple functionalities. For example, motion sensor 610, light sensor 612, and proximity sensor 614 can be coupled to peripherals subsystem 606 to facilitate orientation, lighting, and proximity functions. Other sensors 616 can also be connected to peripherals subsystem 606, such as a global navigation satellite system (GNSS) (e.g., GPS receiver), a temperature sensor, a biometric sensor, magnetometer, or other sensing device, to facilitate related functionalities.

Camera subsystem 620 and optical sensor 622, e.g., a charged coupled device (CCD) or a complementary metal-oxide semiconductor (CMOS) optical sensor, can be utilized to facilitate camera functions, such as recording photographs and video clips. Camera subsystem 620 and optical sensor 622 can be used to collect images of a user to be used during authentication of a user, e.g., by performing facial recognition analysis.

Communication functions can be facilitated through one or more wired and or wireless communication subsystems 624, which can include radio frequency receivers and transmitters and or optical (e.g., infrared) receivers and transmitters. For example, the Bluetooth (e.g., Bluetooth low energy (BTLE)) and or WiFi communications described herein can be handled by wireless communication subsystems 624. The specific design and implementation of communication subsystems 624 can depend on the communication network(s) over which the user device 600 is intended to operate. For example, user device 600 can include communication subsystems 624 designed to operate over a GSM network, a GPRS network, an EDGE network, a WiFi or WiMax network, and a Bluetooth™ network. For example, wireless communication subsystems 624 can include hosting protocols such that device 600 can be configured as a base station for other wireless devices and or to provide a WiFi service.

Audio subsystem 626 can be coupled to speaker 628 and microphone 630 to facilitate voice-enabled functions, such as speaker recognition, voice replication, digital recording, and telephony functions. Audio subsystem 626 can be configured to facilitate processing voice commands, voice-printing, and voice authentication, for example.

I/O subsystem 640 can include a touch-surface controller 642 and or other input controller(s) 644. Touch-surface controller 642 can be coupled to a touch-surface 646. Touch-surface 646 and touch-surface controller 642 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch-surface 646.

The other input controller(s) 644 can be coupled to other input/control devices 648, such as one or more buttons, rocker switches, thumb-wheel, infrared port, USB port, and or a pointer device such as a stylus. The one or more buttons (not shown) can include an up/down button for volume control of speaker 628 and or microphone 630.

In some implementations, a pressing of the button for a first duration can disengage a lock of touch-surface 646; and a pressing of the button for a second duration that is longer than the first duration can turn power to user device 600 on or off. Pressing the button for a third duration can activate a voice control, or voice command, module that enables the user to speak commands into microphone 630 to cause the device to execute the spoken command. The user can customize a functionality of one or more of the buttons. Touch-surface 646 can, for example, also be used to implement virtual or soft buttons and or a keyboard.

In some implementations, user device 600 can present recorded audio and or video files, such as MP3, AAC, and MPEG files. In some implementations, user device 600 can include the functionality of an MP3 player, such as an iPod™. User device 600 can, therefore, include a 36-pin connector and or 8-pin connector that is compatible with the iPod. Other input/output and control devices can also be used.

Memory interface 602 can be coupled to memory 650. Memory 650 can include high-speed random access memory and or non-volatile memory, such as one or more magnetic disk storage devices, one or more optical storage devices, and or flash memory (e.g., NAND, NOR). Memory 650 can store an operating system 652, such as Darwin, RTXC, LINUX, UNIX, OS X, Windows, or an embedded operating system such as VxWorks.

Operating system 652 can include instructions for handling basic system services and for performing hardware dependent tasks. In some implementations, operating system 652 can be a kernel (e.g., UNIX kernel). In some implementations, operating system 652 can include instructions for performing voice authentication.

Memory 650 can also store communication instructions 654 to facilitate communicating with one or more additional devices, one or more computers and or one or more servers. Memory 650 can include graphical user interface instructions 656 to facilitate graphic user interface processing; sensor processing instructions 658 to facilitate sensor-related processing and functions; phone instructions 660 to facilitate phone-related processes and functions; electronic messaging instructions 662 to facilitate electronic messaging-related process and functions; web browsing instructions 664 to facilitate web browsing-related processes and functions; media processing instructions 666 to facilitate media processing-related functions and processes; GNSS/Navigation instructions 668 to facilitate GNSS and navigation-related processes and instructions; and or camera instructions 670 to facilitate camera-related processes and functions.

Memory 650 can store application (or “app”) instructions and data 672, such as instructions for the apps described above in the context of FIGS. 1-4. Memory 650 can also store other software instructions 674 for various other software applications in place on device 600. The described features can be implemented in one or more computer programs that can be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions can include, by way of example, both general and special purpose microprocessors, and the sole processor or one of multiple processors or cores, of any kind of computer. Generally, a processor can receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A computing system for generating recommendations comprising:
a processor; and
a non-transitory computer-readable storage device storing computer-executable instructions, the instructions operable to cause the processor to perform operations comprising:
detecting a presence of a user on a content platform;
generating a recommendation for the user via a contextual bandit model and a non-linear machine learning model, the recommendation comprising one or more recommended items, the non-linear machine learning model operating as an oracle for the contextual bandit model and being trained to predict future rewards for the one or more recommended items; and
collecting a reward from an interaction between the user and the one or more recommended items to re-train the non-linear machine learning model.

2. The computing system of claim 1, wherein the operations comprise:
concatenating user features associated with the user, item features associated with the one or more recommended items, and context features to generate a vector;
assigning the collected reward to the vector to generate a vector-reward pair; and
re-training, with the vector-reward pair, the non-linear machine learning model to predict future rewards for the one or more recommended items, wherein the training utilizes a plurality of weights of the user features, item features, and context features in a hyperparameter search space.

3. The computing system of claim 1, wherein training the non-linear machine learning model comprises training a tree-based machine learning model or a deep learning model.

4. The computing system of claim 1, wherein collecting the reward comprises at least one of collecting a binary reward, a multi-class reward, or a continuous reward.

5. The computing system of claim 1, wherein training the non-linear machine learning model comprises calculating, for each hyperparameter selection, an average reward uniqueness indicator (average RUI) value based on cross-validation data.

6. The computing system of claim 4, wherein training the non-linear machine learning model comprises constraining each average RUI value with a predefined threshold.

7. The computing system of claim 1, wherein generating the recommendation for the user via the contextual bandit model is performed based on exploration or exploitation.

8. A computer-implemented method, performed by at least one processor, for generating recommendations comprising:
detecting a presence of a user on a content platform;
generating a recommendation for the user via a contextual bandit model and a non-linear machine learning model, the recommendation comprising one or more recommended items, the non-linear machine learning model operating as an oracle for the contextual bandit model and being trained to predict future rewards for the one or more recommended items; and
collecting a reward from an interaction between the user and the one or more recommended items to re-train the non-linear machine learning model.

9. The computer-implemented method of claim 8, wherein the operations comprise:
concatenating user features associated with the user, item features associated with the one or more recommended items, and context features to generate a vector;
assigning the collected reward to the vector to generate a vector-reward pair; and
re-training, with the vector-reward pair, the non-linear machine learning model to predict future rewards for the one or more recommended items, wherein the training utilizes a plurality of weights of the user features, item features, and context features in a hyperparameter search space.

10. The computer-implemented method of claim 8, wherein training the non-linear machine learning model comprises training a tree-based machine learning model or a deep learning model.

11. The computer-implemented method of claim 8, wherein collecting the reward comprises at least one of collecting a binary reward, a multi-class reward, or a continuous reward.

12. The computer-implemented method of claim 8, wherein training the non-linear machine learning model comprises calculating, for each hyperparameter selection an average reward uniqueness indicator (average RUI) value based on cross-validation data.

13. The computer-implemented method of claim 12, wherein training the non-linear machine learning model comprises constraining each average RUI value with a predefined threshold.

14. The computer-implemented method of claim 8, wherein generating the recommendation for the user via the contextual bandit model is performed based on exploration or exploitation.

15. A computer-implemented method, performed by at least one processor, for training a model to generate recommendations comprising:
collecting a reward from an interaction between a user and one or more recommended items, the one or more recommended items being generated by a contextual bandit model;
concatenating user features associated with the user, item features associated with the one or more recommended items, and context features to generate a vector;
assigning the collected reward to the vector to generate a vector-reward pair; and
training, with the vector-reward pair, a non-linear machine learning model to predict future rewards for the one or more recommended items, wherein the training utilizes a plurality of weights of the user features, item features, and context features in a hyperparameter search space and the non-linear machine learning model operates as an oracle for the contextual bandit model.

16. The computer-implemented method of claim 15, wherein training the non-linear machine learning model comprises training a tree-based machine learning model or a deep learning model.

17. The computer-implemented method of claim 15, wherein collecting the reward comprises at least one of collecting a binary reward, a multi-class reward, or a continuous reward.

18. The computer-implemented method of claim 15, wherein training the non-linear machine learning model comprises calculating, for each hyperparameter selection, an average reward uniqueness indicator (average RUI) value based on cross-validation data.

19. The computer-implemented method of claim 18, wherein training the non-linear machine learning model comprises constraining each average RUI value with a predefined threshold.

20. The computing system of claim 15, wherein training the non-linear machine learning model comprises training a tree-based machine learning model or a deep learning model.
